(19) United States
(12) Patent Application Publication
(10) Pub. No.: US 2016/0140085 A1
(43) Pub. Date: May 19, 2016

(54) SYSTEM AND METHOD FOR PREVIEWING E-READING CONTENT

(71) Applicant: Kobo Inc., Toronto (CA)

(72) Inventors: Wendy Reid, Mississauga (CA); Benjamin Landau, Toronto (CA)

(21) Appl. No.: 14/546,753

(22) Filed: Nov. 18, 2014

(51) Int. Cl. G06F 17/21; G06F 3/0488; G06F 3/0483; G06F 3/0484

(52) U.S. Cl. CPC G06F 17/212; G06F 3/04842; G06F 3/0488; G06F 3/0483

(57) ABSTRACT

A computing device includes a housing and a display assembly having a screen and a set of touch sensors. The housing at least partially circumvents the screen so that the screen is viewable. A processor is provided within the housing to display content pertaining to an e-book on the screen of the display assembly. The processor further detects a first user interaction with the set of touch sensors and interprets the first user interaction as a first user input corresponding with a selection of at least a portion of the displayed content. The processor then uses the selected content to generate a preview for the e-book to be shared via a network.

### TECHNICAL FIELD

Examples described herein relate to generating and sharing previews for e-books that include user-selected content.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

Some electronic personal display devices are purpose built devices that are designed to perform especially well at displaying readable content. For example, a purpose built purpose build device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

There also exist numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for utilizing applications and providing e-book services on a computing device, according to an embodiment.

FIG. 2 illustrates an example of an e-reading device or other electronic personal display device, for use with one or more embodiments described herein.

FIGS. 3A-3B illustrate an embodiment of an e-reading device that enables a user to create customized e-book previews, according to one or more embodiments.

FIGS. 4A-4D illustrate embodiments of an e-reading device that displays customized e-book previews, according to one or more embodiments.

FIG. 5 illustrates an e-reading system for displaying e-book content, according to one or more embodiments.

FIG. 6 illustrates a method of generating customized e-book previews, according to one or more embodiments.

### DETAILED DESCRIPTION

Embodiments described herein provide for a system and method for generating customized previews for e-books. A user of a computing device may select content from an e-book that he or she wishes to share with others (e.g., to interest them in reading the corresponding e-book). A book preview logic may then generate a preview for the corresponding e-book, which includes the selected content, to be shared with others (e.g., via a web-based link). For example, other users may view the preview on their respective e-reading devices and/or through a web browser.

According to some embodiments, a computing device includes a housing and a display assembly having a screen and a set of touch sensors. The housing at least partially circumvents the screen so that the screen is viewable. A processor is provided within the housing to display content pertaining to an e-book on the screen of the display assembly. The processor may further detect a first user interaction with the set of touch sensors, and interpret the first user interaction as a first user input corresponding with a selection of at least a portion of the displayed content. The processor may then use the selected content to generate a first preview for the e-book to be shared via a network. For example,

The first preview may comprise a product page including at least one of a book cover, a book title, an author, a genre, or a description for the e-book. Further, the first preview may include a link to purchase or download the e-book. For some embodiments, the processor may upload the first preview to a server on the network and generate a link to the first preview stored on the server. More specifically, the first preview may be stored in association with a user account for a user of the computing device.

Further, for some embodiments, the processor may receive a second preview via the network. The processor may then selectively display the second preview on the screen of the display assembly in response to a second user input. Specifically, the second preview may include at least a portion of text from another e-book. For example, the portion of text may be selected by a user of another computing device associated with the server. For some embodiments, the processor may display a notification on the screen of the display assembly upon receiving the second preview.

Among other benefits, examples described herein provide an enhanced reading experience to users of e-reader devices (or similar computing devices that operate as e-reading devices). Specifically, the book preview logic allows users to create customized previews for e-books that they own and/or are reading. For example, a user may create a preview around a portion of text that is particularly engaging and/or potentially interesting to his or her target audience (e.g., friends, family, followers, etc.). This allows users to create targeted book previews, which are more likely to lead to increased sales of e-books.

“E-books” are a form of an electronic publication that can be viewed on computing devices with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory.

Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

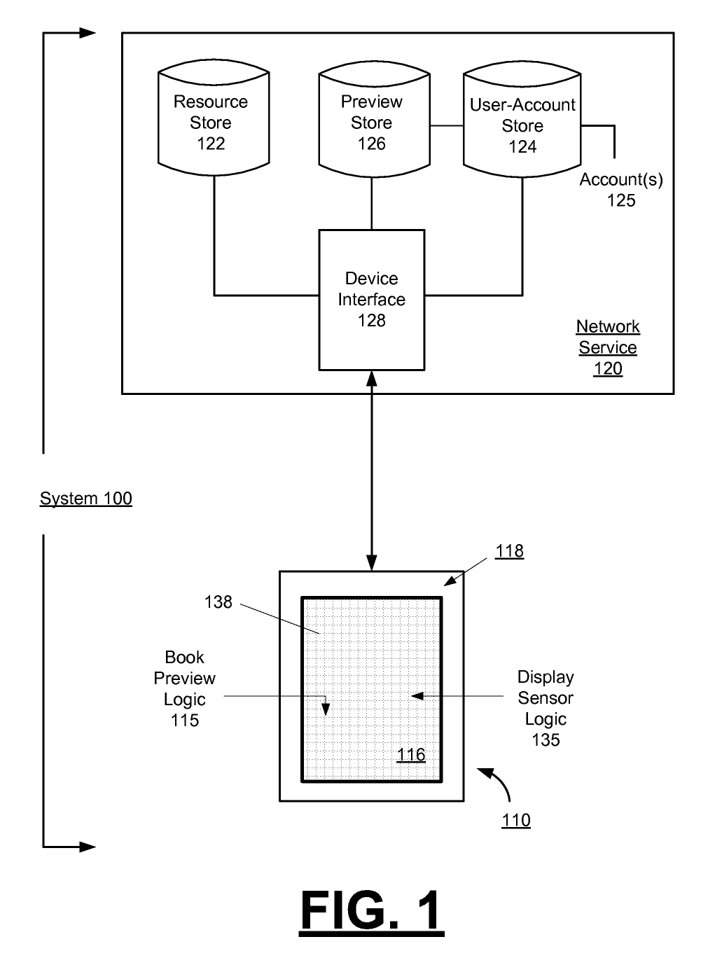

FIG. 1 illustrates a system 100 for utilizing applications and providing e-book services on a computing device, according to an embodiment. In an example of FIG. 1, system 100 includes an electronic display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reading application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122, a user account store 124, and a preview store 126. The user account store 124 can associate the e-reading device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device. The preview store 126 may store book previews that are created and/or shared by users of the network service 120. For example, each book preview in the preview store 126 may be associated with a particular user account 125 in the user account store 124.

With reference to an example of FIG. 1, e-reading device 110 can include a display screen 116 and a housing 118. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing 118 can also be integrated with touch sensors to provide one or more touch sensing regions, for example, on the bezel and/or back surface of the housing 118. The e-reading device 110 may therefore detect and interpret user input made through interaction with the touch sensors 138.

According to some embodiments, the e-reading device 110 includes display sensor logic 135 to detect and interpret user input made through interaction with the touch sensors 138. By way of example, the display sensor logic 135 can detect a user making contact with the touch sensing region of the display 116. For some embodiments, the display sensor logic 135 may interpret the user contact as a type of user input corresponding with the selection of a portion (e.g., of text) of the e-book content provided on the display 116. For example, the selected e-book content may coincide with a touch sensing region of the display 116 formed by one or more of the touch sensors 138. The user input may correspond to, for example, a tap-and-hold input, a double-tap input, or a tap-and-drag input.

In some embodiments, the e-reading device 110 includes features for providing functionality related to generating book previews. For example, the e-reading device 100 can include book preview logic 115, which generates previews for e-books based on user-selected e-book content. For example, upon detecting a user input corresponding with the selection of a particular portion of an e-book (e.g., page and/or selected text), the book preview logic 115 may create a book preview for the corresponding e-book. The book preview may contain a product information page (e.g., including cover art, title, author, genre, and/or description pertaining to the e-book) and the user-selected content. For some embodiments, the book preview may also contain a link to purchase and/or download the corresponding e-book from the network service 120.

The book preview may be stored in the preview store 126 on the network service 120 (e.g., corresponding with the particular user account 125 associated with the e-reading device 110). For some embodiments, the book preview may then be shared with other e-reading devices associated with the network service 120. For example, after creating the preview, the book preview logic 115 may prompt the user to input one or more user accounts 125 that the user wishes to share the preview with. The network service 120 may then send the preview to the particular e-reading devices associated with the identified user accounts 125. For some embodiments, the book preview may be viewed as a web page and/or within an e-reading application. For example, after creating the preview, the book preview logic 115 may generate a link to the preview stored in the preview store 126. More specifically, the link may be a web-based link that opens the preview in a web browser of any type of computing device (e.g., tablet, laptop, cell phone, PDA, etc.). Thus, the user may share the link via any Internet-connected messaging (e.g., email or instant message), web browsing (e.g., blog or website), and/or social media platform (e.g., Facebook, Twitter, etc.).

The book preview logic 115 can be responsive to various kinds of interfaces and actions in order to enable page transitioning. In one implementation, the user can select a portion of text and/or other e-book content to be used in the preview by interacting with the touch sensing region of the display 116. For example, the user can select an open e-book page (e.g., the page currently on display) by tapping and holding (or double tapping) the display 116. Further, the user can select a portion of text from an e-book (e.g., across one or more e-book pages) by tapping a region of the display 116 coinciding with the beginning of the desired portion of text and, without releasing contact with the display surface, dragging the user's finger to another region of the display 116 coinciding with the end of the desired portion of text.

Hardware Description

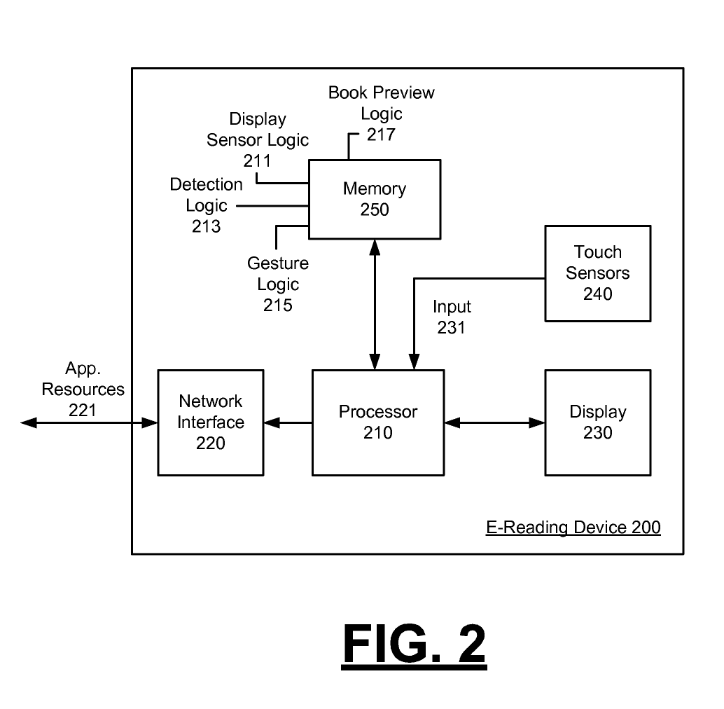

FIG. 2 illustrates an example of an e-reading device 200 or other electronic personal display device, for use with one or more embodiments described herein. In an example of FIG. 2, an e-reading device 200 can correspond to, for example, the device 110 as described above with respect to FIG. 1. With reference to FIG. 2, e-reading device 200 includes a processor 210, a network interface 220, a display 230, one or more touch sensor components 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information, received book previews, etc.), as well as to provide information (e.g., user account information, service requests, shared book previews, etc.). For example, e-reading device 200 can receive application resources 221, such as e-books or media files, that the user elects to purchase or otherwise download from the network service 120. The application resources 221 may also include previews of e-books shared by other users. E-books and/or book previews that are downloaded onto the e-reading device 200 can be stored in the memory 250.

In some implementations, the display 230 can correspond to, for example, a liquid crystal display (LCD), an electrophoretic display (EPD), or a light emitting diode (LED) display that illuminates in order to provide content generated from processor 210. In some implementations, the display 230 can be touch-sensitive. For example, in some embodiments, one or more of the touch sensor components 240 may be integrated with the display 230. In other embodiments, the touch sensor components 240 may be provided (e.g., as a layer) above or below the display 230 such that individual touch sensor components 240 track different regions of the display 230. Further, in some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the touch sensor components 240, the display 230, and/or other input mechanisms (e.g., buttons, keyboard, mouse, microphone, etc.). With reference to examples described herein, the processor 210 can respond to input 231 from the touch sensor components 240. In some embodiments, the processor 210 responds to inputs 231 from the touch sensor components 240 in order to facilitate or enhance e-book activities such as generating e-book content on the display 230, performing page transitions of the e-book content, powering off the device 200 and/or display 230, activating a screen saver, launching an application, and/or otherwise altering a state of the display 230.

In some embodiments, the memory 250 may store display sensor logic 211 that monitors for user interactions detected through the touch sensor components 240 provided with the display 230, and further processes the user interactions as a particular input or type of input. In an alternative embodiment, the display sensor logic 211 may be integrated with the touch sensor components 240. For example, the touch sensor components 240 can be provided as a modular component that includes integrated circuits or other hardware logic, and such resources can provide some or all of the display sensor logic 211 (see also display sensor logic 135 of FIG. 1). For example, integrated circuits of the touch sensor components 240 can monitor for touch input and/or process the touch input as being of a particular kind. In variations, some or all of the display sensor logic 211 may be implemented with the processor 210 (which utilizes instructions stored in the memory 250), or with an alternative processing resource.

In one implementation, the display sensor logic 211 includes detection logic 213 and gesture logic 215. The detection logic 213 implements operations to monitor for the user contacting a surface of the display 230 coinciding with a placement of one or more touch sensor components 240. The gesture logic 215 detects and correlates a particular gesture (e.g., pinching, swiping, tapping, etc.) as a particular type of input or user action. In some embodiments, the gesture logic 215 may associate the user input with a selection of e-book content to be used in generating a preview for a corresponding e-book. For example, the gesture logic 215 may associate a tapping input (e.g., tap-and-hold or double-tap) with the e-book content currently on display. Alternatively, and/or in addition, the gesture logic 215 may associate a tap-and-drag input with a portion of text and/or other content swiped over by the user. For example, the selected e-book content may comprise text (e.g., words, phrases, equations, etc.) and/or images from the corresponding e-book.

The memory 250 further stores book preview logic 217 to generate previews for e-books based on the user-selected content. For example, the user input (e.g., a “preview selection input”) may correspond with a selection of content (e.g., including text and/or images) from an e-book being read by the user. Upon detecting the user input, the book preview logic 217 may generate a preview for the corresponding e-book that includes at least the user-selected content. For some embodiments, the preview may include a product information page that includes information pertaining to the e-book. For example, the product information page may include cover art, author, genre, book description, and/or other general information about the corresponding e-book. More specifically, the book preview logic 217 may retrieve the information to be used in the product information page from e-book data and/or metadata stored in memory 250. Further, for other embodiments, the preview may include a link or option to purchase and/or download the corresponding e-book.

The book preview may be uploaded to a network resource (e.g., such as the preview store 126 of FIG. 1) via the network interface 220 to be shared with others. For some embodiments, the book preview may be sent to other e-reading devices having access to the network resource. For example, the target devices may be associated with user accounts identified by the user of the e-reading device 200 when creating the book preview. For other embodiments, the book preview logic 217 may create a link to the book preview (e.g., on the network resource) that may be shared across various messaging, web browsing, and/or social media platforms (e.g., by copying and pasting the link). For example, the link may be a web-based link (e.g., URL or HREF) that opens the book preview in a web browser of any computing device.

For some embodiments, the book preview logic 217 may also process book previews received from other users. For example, upon receiving a book preview, the book preview logic 217 may generate a notification on the display 230 indicating that another user has sent a book preview to the user of the e-reading device 200. The book preview logic 217 may then selectively display or render the received book preview on the display 230 based on a subsequent user input. For example, the book preview logic 217 may display the received book preview on the display 230 if the user indicates that he or she would like to view the preview. On the other hand, the book preview logic 217 may delete or store the received book preview in memory 250 (e.g., for future viewing) if the user indicates that he or she does not wish to view the preview.

Customized E-Book Previews

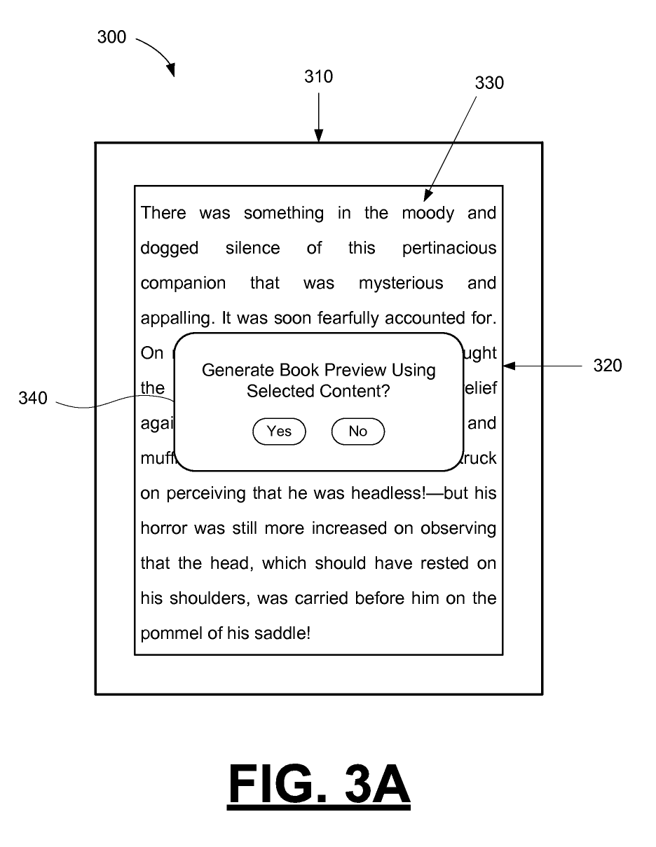

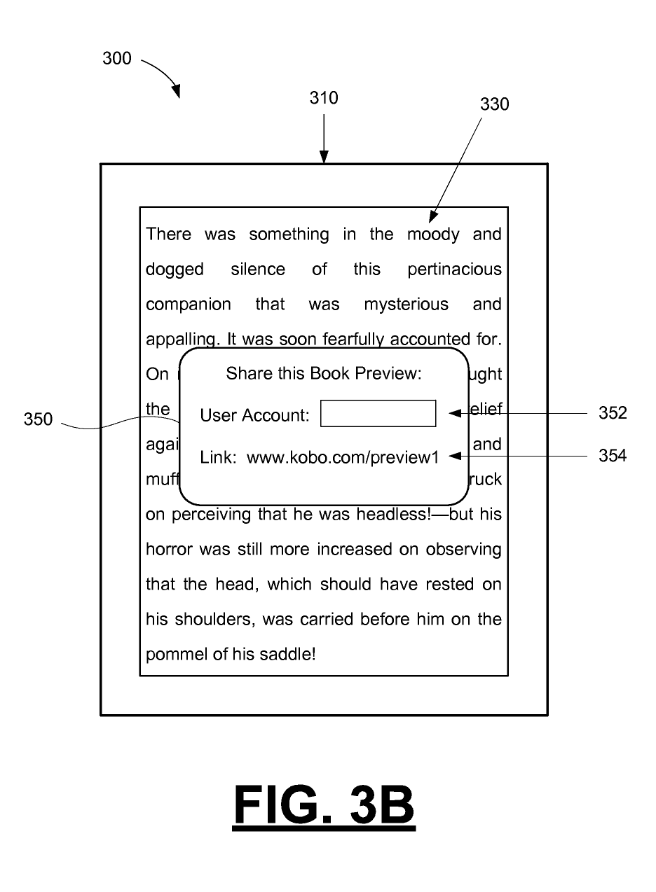

FIGS. 3A-3B illustrate an embodiment of an e-reading device that enables a user to create customized e-book previews, according to one or more embodiments. The e-reading device 300 includes a housing 310 and a display screen 320. The e-reading device 300 can be substantially tabular or rectangular, so as to have a front surface that is substantially occupied by the display screen 320 so as to enhance content viewing. More specifically, the front surface of the housing 310 may be in the shape of a bezel surrounding the display screen 320. The display screen 320 can be part of a display assembly, and can be touch sensitive. For example, the display screen 320 can be provided as a component of a modular display assembly that is touch-sensitive and integrated with housing 310 during a manufacturing and assembly process.

A touch sensing region 330 is provided with at least a portion of the display screen 320. Specifically, the touch sensing region 330 may coincide with the integration of touch sensors with the display screen 320. For some embodiments, the touch sensing region 330 may substantially encompass a surface of the display screen 320. Further, the e-reading device 300 can integrate one or more types of touch-sensitive technologies in order to provide touch sensitivity on the touch sensing region 330 of the display screen 320. It should be appreciated that a variety of well-known touch sensing technologies may be utilized to provide touch-sensitivity, including, for example, resistive touch sensors, capacitive touch sensors (using self and/or mutual capacitance), inductive touch sensors, and/or infrared touch sensors.

For example, the touch-sensing feature of the display screen 320 can be employed using resistive sensors, which can respond to pressure applied to the surface of the display screen 320. In a variation, the touch-sensing feature can be implemented using a grid pattern of electrical elements which can detect capacitance inherent in human skin. Alternatively, the touch-sensing feature can be implemented using a grid pattern of electrical elements which are placed over or just beneath the surface of the display screen 320, and which deform sufficiently on contact to detect touch from an object such as a finger.

With reference to FIG. 3A, e-book content pertaining to an “active” e-book (e.g., an e-book that the user is currently reading) is displayed on the display screen 320. For some embodiments, the e-reading device 300 may respond to user input (e.g., corresponding to a preview selection input) received via the touch sensing region 330 by generating a preview for the active e-book based, at least in part, on user-selected e-book content. For example, a user may select the current e-book page to be used for the preview by tapping-and-holding (or double-tapping) the display screen 320. Alternatively, and/or in addition, the user may select a portion of text from the current e-book page and/or across multiple e-book pages by tapping and dragging the user's finger (or other object) across a region of the display screen 320 coinciding with the desired text. For some embodiments, the e-reading device 300 may limit the user's selection to a certain number of pages, lines of text, and/or number of words (e.g., based on memory and/or copyright constraints).

Upon receiving the preview selection input, the e-reading device may display a menu 340 prompting the user to confirm whether to generate a book preview using the selected e-book content. The user may cancel the book preview creation, for example, by tapping the “No” icon in the menu 340. If the user taps the “Yes” icon in the menu 340, the e-reading device may subsequently generate a book preview based on the user-selected e-book content. For example, the book preview may include the currently displayed e-book page and/or a selected portion thereof.

For some embodiments, the e-reading device 300 may further prompt the user to input one or more intended recipients of the book preview. For example, with reference to FIG. 3B, the e-reading device 300 may display a subsequent menu 350 on the display screen 320, which includes a field 352 to allow the user to enter user account information for one or more intended recipients. More specifically, the user may enter the account information using an on-screen virtual keyboard and/or a peripheral input device (e.g., such as a Bluetooth® keyboard). Accordingly, the e-reading device 300 may forward the book preview to other e-reading devices associated with the one or more user accounts 352 (e.g., via a corresponding network service). For some embodiments, the book preview may be uploaded to, and stored on, the menu 350 may also display a link 354 (e.g., “www.kobo.com/previewl”) to the book preview stored on a corresponding server or network service. For example, the user may copy and paste this link 354 to share the book preview with users of different types of computing platforms (e.g., such as laptops, cell phones, tablets, PDAs, etc.).

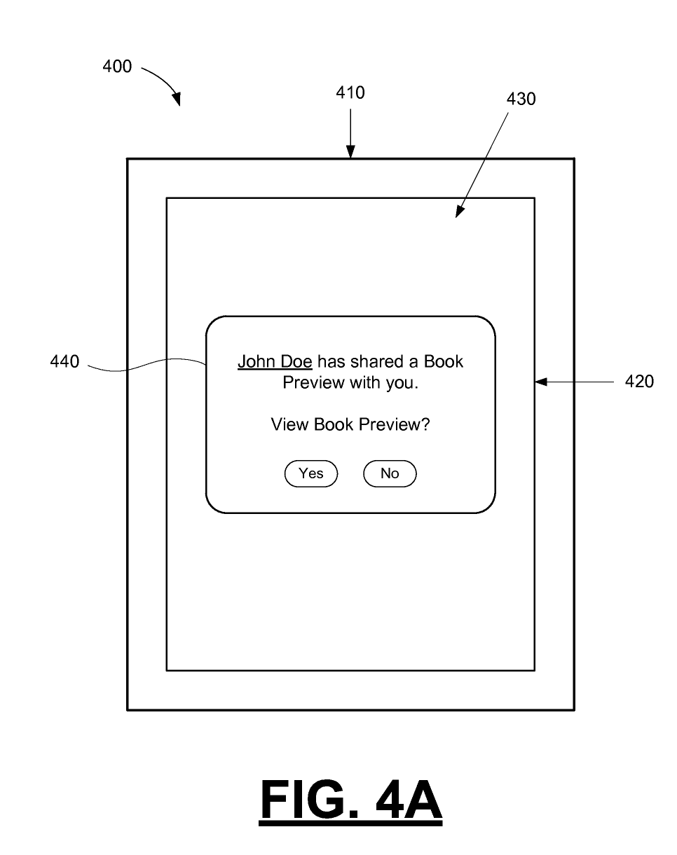

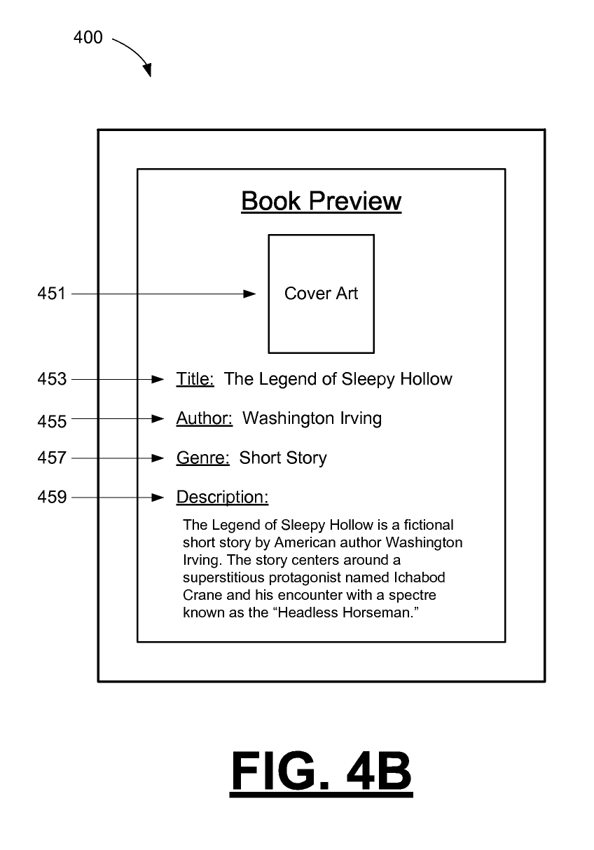

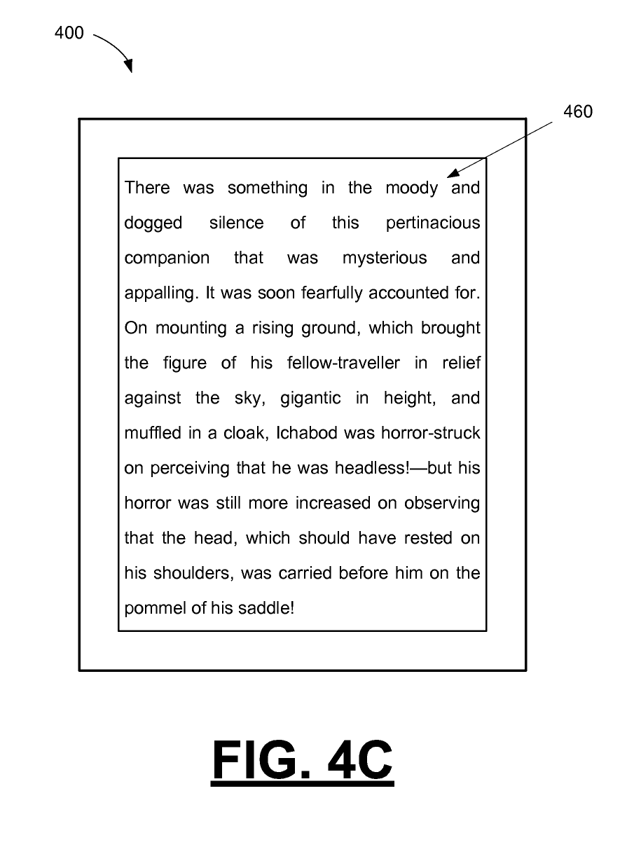

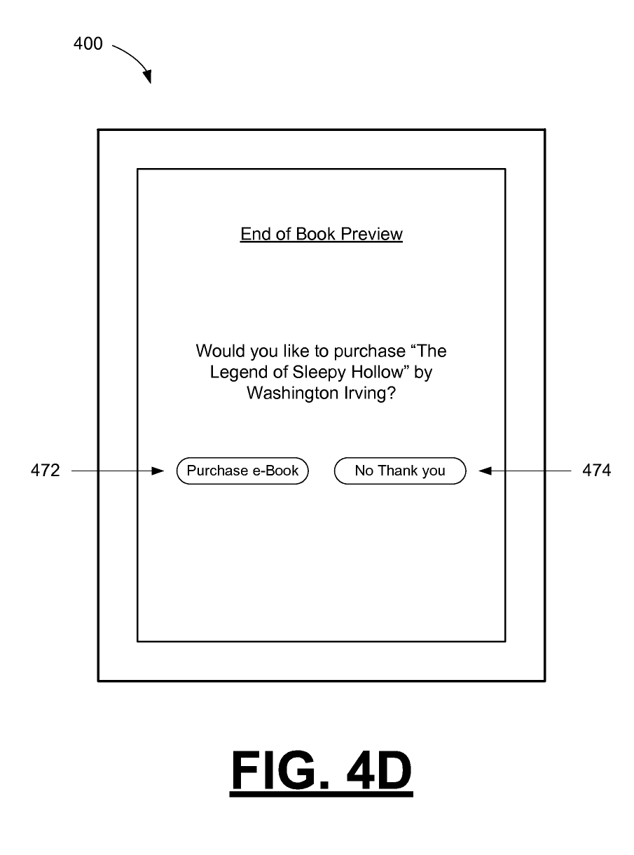

FIGS. 4A-4D illustrate embodiments of an e-reading device that displays customized e-book previews, according to one or more embodiments. The e-reading device 400 includes a housing 410 and a display screen 420. The display screen 420 can be part of a display assembly, and can be touch sensitive. A touch sensing region 430 is provided with at least a portion of the display screen 420. For simplicity, the circuitry and/or hardware components 410-430 may be substantially similar, if not identical, in function to corresponding circuitry and hardware components 310-330 of the e-reading device 300 (e.g., as described above with respect to FIG. 3).

With reference to FIG. 4A, the e-reading device 400 receives a book preview from another user of a corresponding network service. For some embodiments, the e-reading device 400 may display a notification 440 on the display screen 420 upon receiving the book preview. For example, the notification 440 may identify the user (e.g., by name and/or user account) that sent the book preview and/or the title of the corresponding e-book. For some embodiments, the notification 440 may further prompt the user to view or ignore the received book preview. For example, the user may tap the “No” icon on the notification 440 to ignore the book preview. In response to a “No” input, the e-reading device 440 may store the book preview in memory (e.g., for future viewing) or delete the book preview altogether.

If the user taps the “Yes” icon on the notification 440, the e-reading device 400 may proceed to download, render, and/or display the received book preview on the display screen 420. For example, with reference to FIG. 4B, the book preview may include a product page including generic information about the e-book. For some embodiments, the product page may include at least one of, a book cover 451, title information 453, author information 455, genre information 457, and/or a brief description 459 of the corresponding e-book. The book cover 451 may include cover art that may be found on a cover and/or book jacket of the corresponding book or e-book. For some embodiments, the title information 453 (e.g., “The Legend of Sleepy Hollow”) and author information 455 (e.g., “Washington Irving”) may be included as part of the book cover 451 (e.g., as this information is typically found on the cover or jacket of a book and/or e-book). The genre information 457 and description 459 may be provided by a publisher of the corresponding book or e-book, and may be included as data and/or metadata associated with the corresponding e-book.

For some embodiments, the user may view the user-selected content by effecting a page turn or page transition from the product information page. In one implementation, the user can signal a page transition by, for example, interacting with the touch sensing region of the display screen 420. For example, the user can trigger a page turn input by tapping the surface of the display screen 420. Alternatively, and/or additionally, the user may trigger a page turn input by swiping the surface of the display 420 (e.g., in the direction of the desired page turn or transition).

With reference to FIG. 4C, the e-reading device 400 may respond to a page turn input by displaying the user-selected content 460 associated with the received book preview. For some embodiments, the user-selected content 460 may include a page of e-book content, multiple pages of e-book content, and/or a portion of text (and/or other content) selected from one or more e-book pages. The user may advance through the user-selected preview content, for example, by effecting subsequent page transition inputs (e.g., by tapping and/or swiping the surface of the display 420).

For some embodiments, the e-reading device 400 may enable the user to purchase and/or download the e-book at the end of the book preview. For example, with reference to FIG. 4D, the e-reading device 400 may display a page prompting the user to purchase the corresponding e-book 472 or decline to purchase the e-book 474 (e.g., by tapping the corresponding regions of the display 420). If the user taps the “purchase” icon 472, the e-reading device 400 may redirect the user to an e-book purchasing page (e.g., an online bookstore). However, if the user taps the “no” icon 474, the e-reading device may subsequently close or exit out of the book preview.

It should be noted that the layout and content of the book preview of FIGS. 4A-4D are described for exemplary purposes only. For example, in certain implementations, the product information page may include fewer or more e-book information than that shown in FIG. 4B. Further, the user-selected preview content may include more or less e-book content than that shown in FIG. 4C. Still further, the order in which the pages of the book preview are presented to the user may differ from the order described above. For example, in some implementations, the book preview may begin with the user-selected content (e.g., instead of the product information page) to pique the user's interest in the corresponding e-book.

E-Book Preview Functionality

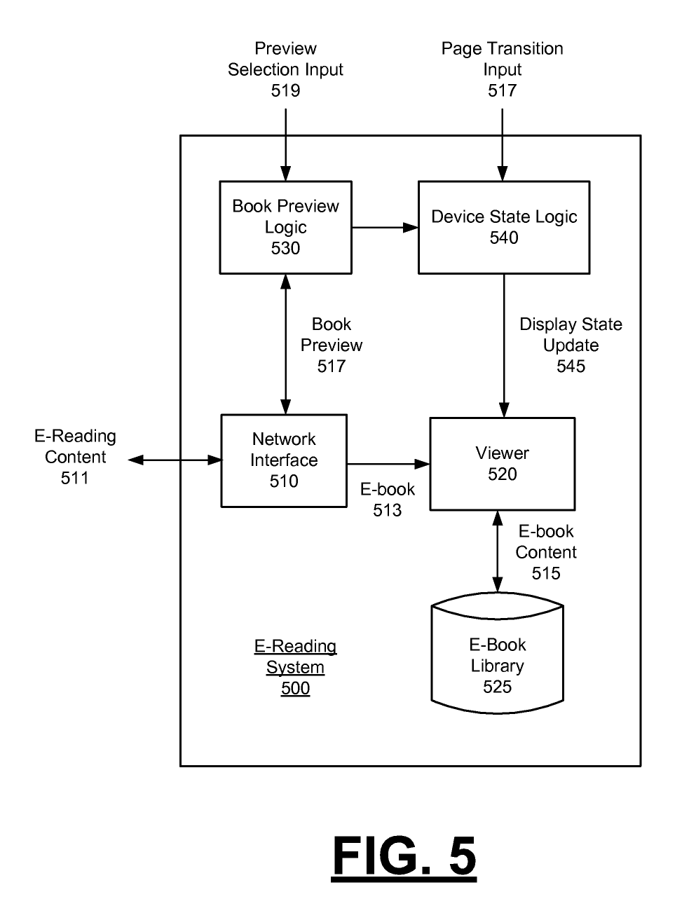

FIG. 5 illustrates an e-reading system 500 for displaying e-book content, according to one or more embodiments. An e-reading system 500 can be implemented as, for example, an application or device, using components that execute on, for example, an e-reading device such as shown with examples of FIGS. 1, 2, 3A-3B and 4A-4D. Furthermore, an e-reading system 500 such as described can be implemented in a context such as shown by FIG. 1, and configured as described by an example of FIG. 2, FIGS. 3A-3B, and FIGS. 4A-4D.

In an example of FIG. 5, a system 500 includes a network interface 510, a viewer 520, book preview logic 530, and device state logic 540. As described with an example of FIG. 1, the network interface 510 can correspond to a programmatic component that communicates with a network service in order to receive data and programmatic resources. For example, the network interface 510 can receive e-reading content 511 from the network service 120. More specifically, the e-reading content 511 may include e-books 511, which the user purchases and/or downloads, and book previews 517. E-books 513 can be stored as part of an e-book library 525 with memory resources of an e-reading device (e.g., see memory 250 of e-reading device 200). The book previews 517 may include content from e-books not stored in the e-book library 525.

The viewer 520 can access e-book content 515 from a selected e-book, provided with the e-book library 525. The e-book content 515 can correspond to one or more pages that comprise the selected e-book. Additionally, the e-book content 515 may correspond to portions of (e.g., selected sentences from) one or more pages of the selected e-book. The viewer 520 renders the e-book content 515 on a display screen at a given instance, based on a display state of the device 500. The display state rendered by the viewer 520 can correspond to a particular page, set of pages, or portions of one or more pages of the selected e-book that are displayed at a given moment.

The book preview logic 530 can generate previews for e-books in the e-book library 525 in response to receiving a preview selection input 519 associated with content (e.g., including text and/or images) from a corresponding e-book. For example, the preview selection input may be provided by a user tapping and dragging (e.g., highlighting) a finger or other object across the surface of a display of the e-reading system 500 that coincides with the desired content. The book preview logic 530 may then generate a book preview 517 that includes at least the user-selected e-book content. For some embodiments, the book preview 517 may include a product information page that includes information (e.g., cover, author, genre, description, etc.) pertaining to the e-book. Further, for some embodiments, the book preview 517 may include a link or option to purchase and/or download the corresponding e-book.

The book preview logic 530 may upload the book preview 517 to a network service (e.g., via the network interface 510) to be shared with one or more recipients. For example, the network service may then forward the book preview 517 to e-reading systems associated with the one or more recipients. Alternatively, and/or in addition, the book preview logic 530 may generate a link to the book preview 517, stored on the network service, to be shared with the one or more recipients. For example, the book preview 517 may be viewed in a web browser and/or an e-reading application on a recipient's device.

The device state logic 540 can be provided as a feature or functionality of the viewer 520. Alternatively, the device state logic 540 can be provided as a plug-in or as independent functionality from the viewer 520. The device state logic 540 can signal display state updates 545 to the viewer 520. The display state update 545 can cause the viewer 520 to change or after its current display state. For example, the device state logic 540 may be responsive to page transition inputs 517 by signaling display state updates 545 corresponding to page transitions (e.g., single page transition, mufti-page transition, or chapter transition).

For some embodiments, the device state logic 540 may also be responsive to the book preview logic 530 to display received book previews 517 on the viewer 520. For example, the book preview logic 530 may receive book previews 517 (e.g., via the network interface 510) shared by users of other e-reading systems. The book preview logic 530 may then render or activate the received book preview 517. For example, the book preview logic 530 may instruct the device state logic 540 to generate display state updates 545 to display corresponding pages and/or portions of the received book preview 517 on the viewer 520.

Methodology

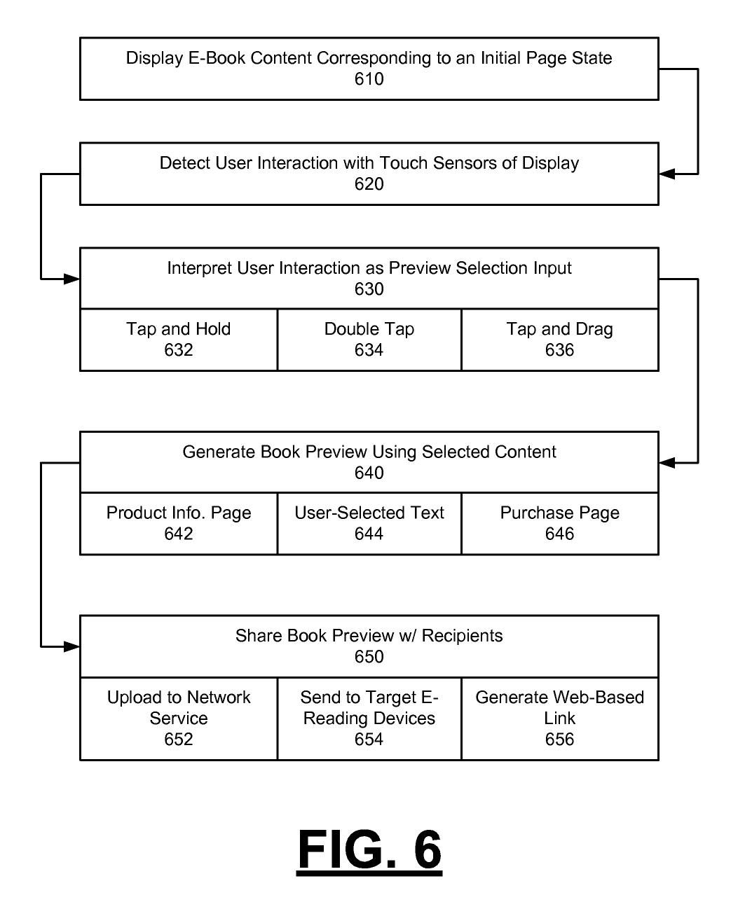

FIG. 6 illustrates a method of generating customized e-book previews, according to one or more embodiments. In describing an example of FIG. 6, reference may be made to components such as described with FIGS. 2, 3A-3B and 4A-4D for purposes of illustrating suitable components for performing a step or sub-step being described.

With reference to an example of FIG. 2, the e-reading device 200 may first display e-book content corresponding to an initial page state (610). For example, the device 200 may display a single page (or portions of multiple pages) of an e-book corresponding to the content being ready by the user. Alternatively, the device 200 may display multiple pages side-by-side to reflect a display mode preference of the user. The e-reading device 200 may then detect a user interaction with one or more touch sensors provided (or otherwise associated) with the display 230 (620). For example, the processor 210 can receive inputs 231 from the touch sensor components 240.

The e-reading device 200 may interpret the user interaction as a preview selection input (630). More specifically, the processor 210, in executing the book preview logic 217, may associate the user interaction with a selection of a portion of e-book content (e.g., including text and/or images) provided on the display 230. For some embodiments, the processor 210 may interpret a tap-and-hold input (632) as a preview selection input associated with an open e-book page. For other embodiments, the processor 210 may interpret a double-tap input (634) as a preview selection input associated with the open e-book page. Still further, for some embodiments, the processor 210 may interpret a tap-and-drag input (636) as a preview selection input associated with a selection of e-book content coinciding with one or more touch sensing regions of the display 230 being swiped. In some instances, the amount and/or type of user-selectable content may be limited by the book preview logic 217, for example, based on memory and/or copyright restrictions.

The e-reading device 200 may then generate a book preview using the selected e-book content (640). More specifically, the processor 210, in executing the book preview logic 217, may generate a customized preview for the corresponding e-book that includes the user-selected e-book content. For some embodiments, the preview may include a product information page (e.g., as shown in FIG. 4B) that includes information pertaining to the e-book (642). For example, the product information page may include cover art, author, genre, book description, and/or other general information pertaining to the corresponding e-book. The preview may further include one or more additional pages of user-selected e-book content (e.g., as shown in FIG. 4C) (644). More specifically, the user-selected content may include a targeted selection of e-book content that is intended for particular recipient and/or group of recipients. Further, for some embodiments, the preview may also include a purchase page (e.g., as shown in FIG. 4D) to allow a recipient or viewer of the book preview to purchase and/or download the corresponding e-book (646).

Finally, the e-reading device 200 may share the book preview with one or more recipients (650). For some embodiments, the processor 210, in executing the book preview logic 217 may first upload the book preview to a network service or server (652). For example, the book preview may be stored in the preview store 126, in association with a corresponding user account 125, on the network service 120 of FIG. 1. For some embodiments, the network service may then forward the book preview to one or more target e-reading devices (654). For example, the target e-reading devices may also be associated with the network service 120, and may each be identified by a respective user account 125 in the user account store 124. For other embodiments, the processor 210 may generate a web-based link to the book preview stored on the network service (656). The link may then be shared with users of various different computing platforms. For example, the link may cause the corresponding book preview to be opened or rendered in a web browser and/or e-reading application.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a display assembly including a screen;
a housing that at least partially circumvents the screen so that the screen is viewable;
a set of touch sensors provided with the display assembly; and
a processor provided within the housing, the processor operating to:
display content pertaining to an e-book on the screen of the display assembly;
detect a first user interaction with the set of touch sensors;
interpret the first user interaction as a first user input corresponding with a selection of at least a portion of the displayed content; and
use the selected content to generate a first preview for the e-book to be shared via a network.

2. The computing device of claim 1, wherein the first preview comprises a product page including at least one of a book cover, a book title, an author, a genre, or a description for the e-book.

3. The computing device of claim 1, wherein the first preview includes a link to purchase or download the e-book.

4. The computing device of claim 1, wherein the first processor is to further:
upload the first preview to a server on the network; and
generate a link to the first preview stored on the server.

5. The computing device of claim 4, wherein the first preview is stored in association with a user account for a user of the computing device.

6. The computing device of claim 1, wherein the processor is to further:
receive a second preview via the network, wherein the second preview includes at least a portion of text from another e-book.

7. The computing device of claim 6, wherein the second preview is sent from another computing device associated with the server.

8. The computing device of claim 7, wherein the portion of text is selected by a user of the other computing device.

9. The computing device of claim 6, wherein the processor is to further:
display a notification on the screen of the display assembly upon receiving the second preview.

10. The computing device of claim 6, wherein the processor is to further:
selectively display the second preview on the screen in response to a second user input.

11. A method for operating a computing device, the method being implemented by one or more processors and comprising:
displaying content pertaining to an e-book on the screen of a display assembly of the computing device;
detecting a first user interaction with a set of touch sensors provided with the display assembly;
interpreting the first user interaction as a first user input corresponding with a selection of at least a portion of the displayed content; and
using the selected content to generate a first preview for the e-book to be shared via a network.

12. The method of claim 11, wherein the first preview comprises a product page including at least one of a book cover, a book title, an author, a genre, or a description for the e-book.

13. The method of claim 11, wherein the first preview includes a link to purchase or download the e-book.

14. The method of claim 11, further comprising:
uploading the first preview to a server on the network; and
generating a link to the first preview stored on the server.

15. The method of claim 11, further comprising:
receiving a second preview via the network, wherein the second preview includes at least a portion of text from another e-book.

16. The method of claim 15, wherein the second preview is sent from another computing device associated with the server.

17. The method of claim 16, wherein the portion of text is selected by a user of the other computing device.

18. The method of claim 15, further comprising:
displaying a notification on the screen of the display assembly upon receiving the second preview.

19. The method of claim 15, further comprising:
selectively displaying the second preview on the screen in response to a second user input.

20. A non-transitory computer-readable medium that stores instructions, that when executed by one or more processors, cause the one or more processors to perform operations that include:
displaying content pertaining to an e-book on the screen of a display assembly of the computing device;
detecting a first user interaction with a set of touch sensors provided with the display assembly;
interpreting the first user interaction as a first user input corresponding with a selection of at least a portion of the displayed content; and
using the selected content to generate a preview for the e-book to be shared via a network.
